(19) United States
(12) Patent Application Publication
(10) Pub. No.: US 2024/0074443 A1
(43) Pub. Date: Mar. 7, 2024

(54) High Collagen Brownie and Methods of Making

(71) Applicant: General Mills, Inc., Minneapolis, MN (US)

(72) Inventors: Rachel Beck, St. Louis Park, MN (US); Emily Fortener, Plymouth, MN (US); Carrie Nelson, Dayton, MN (US); Sara Rosene, New Hope, MN (US); Brian Sadowski, Chanhassen, MN (US); Kelsey Ann Sneddon, Maple Grove, MN (US); Carol S. Uy, New Brighton, MN (US); Katie Wanner, Minneapolis, MN (US)

(21) Appl. No.: 18/241,390

(22) Filed: Sep. 1, 2023

Related U.S. Application Data
(60) Provisional application No. 63/403,163, filed on Sep. 1, 2022.

(51) Int. Cl. A21D 2/26; A21D 2/36

(52) U.S. Cl. CPC A21D 2/261; A21D 2/36

(57) ABSTRACT

A soft baked, shelf stable brownie including a high amount of hydrolyzed collagen that achieves an indulgent texture and flavor, yet retains a soft, moist eating experience over an extended shelf life is described. The brownie includes pantry friendly ingredients to form a matrix that includes collagen, chia seed, a flour content that includes at least a portion that is gluten-free, fiber and/or sugar syrup, and fat to achieve an indulgent eating experience. Methods of making a soft baked brownie are also disclosed.

### CROSS REFERENCE TO RELATED APPLICATIONS

This application claims the benefit of U.S. Provisional Patent Application No. 63/403,163, filed on Sep. 1, 2022, and titled “High Collagen Brownie and Methods of Making”. The entire content of this application is incorporated by reference.

### BACKGROUND

Consumers are increasingly looking for foods that meet their nutritional needs without requiring preparation. Shelf stable baked snack items are a category of ready-to-eat foods that can be challenging to make fit both nutritional needs and a desired eating experience. Hydrolyzed collagen (also termed collagen peptides) have been shown to provide skin health benefits but must be consumed in relatively high amounts to achieve those benefits. While hydrolyzed collagen in the form of supplements, such as hydrolyzed collagen capsules, can provide skin health benefits, supplements are not generally considered an enjoyable form for consumption. Thus, there is a need for good-tasting ready-to-eat products that include sufficient hydrolyzed collagen content to provide a skin health benefit and retain a desirable eating experience over shelf life.

### SUMMARY

The present disclosure relates to a brownie that includes a relatively high hydrolyzed collagen content and retains a soft, moist eating experience over shelf life. In many cases, a brownie provided herein can include ingredients considered by consumers to be “pantry friendly” by excluding ingredients, such as gums, glycerol and other sugar alcohols (e.g., erythritol), and high fructose corn syrup. In some cases, a brownie provided herein can also exclude high intensity sweeteners, such as stevia, sucralose, and aspartame.

Provided herein are high collagen brownies.

A shelf stable baked brownie is provided herein. The brownie includes a total protein content of from about 15% to about 30% by weight of the brownie, a moisture content of about 6% to about 14% by weight, and a water activity (Aw) of less than 0.7, and has a stable texture over at least 4 months. The brownie provided herein has a matrix in an amount of at least 65% by weight of the brownie, where the matrix includes: a. flour content in an amount of about 15% to about 30% by weight of the matrix, the flour content comprising a flour derived from a source that does not contain gluten in an amount of at least 50% by weight of the flour content; b. hydrolyzed collagen in an amount of about 8% to about 14% by weight of the matrix, the hydrolyzed collagen having an average molecular weight of 10,000 g/mol or less; c. chia seed in an amount of about 1% to about 6% by weight of the matrix; d. one or more syrup in an amount of about 12% to about 21% by weight of the matrix; and e. fat in an amount of about 7% to about 12% by weight of the matrix.

In some embodiments, the flour content can contribute protein in an amount of at least 10% by weight of the total protein content. In some embodiments, the flour content can include almond flour. In some embodiments, the flour content can be 100% derived from a source that does not contain gluten.

In some embodiments, the matrix can include cocoa in an amount of up to 7% by weight of the matrix.

In some embodiments, the syrup can include one or more of honey, soluble corn fiber, inulin, or any combination thereof. In some embodiments, the syrup can include honey in an amount of about 5% to about 17% by weight of the matrix. In some embodiments, the syrup can include soluble corn fiber in an amount of about 7% to about 17% by weight of the matrix.

In some embodiments, the fat can include coconut oil.

In some embodiments, the brownie can contain less than 35% by weight sugar.

In some embodiments, the brownie can contain no sugar alcohol, no gums, no high fructose corn syrup, and no high intensity sweeteners.

A method of making a shelf stable baked brownie is also provided. The method includes: a. at least partially hydrating chia seed in water; b. combining the at least partially hydrated chia seed with one or more syrup and a fat in liquid form to form a liquid mixture; c. combining the liquid mixture with one or more flour and hydrolyzed collagen to form a dough or batter, the dough or batter having a moisture content of about 10% to about 45%; d. forming the dough or batter; e. cooking the formed dough or batter to achieve a moisture of about 6% to about 14% to produce the brownie as described herein.

In some embodiments, the method can include combining inclusions with the dough or batter prior to forming.

In some embodiments, the dough or batter can include a leavening agent.

In some embodiments, the forming step can include forming a flat slab and cutting the flat slab into pieces prior to or after cooking. In some embodiments, the forming step can include forming a rope and cutting the rope prior to or after cooking. In some embodiments, the forming step can include extruding individual pieces. In some embodiments, the forming step can include depositing the dough or batter in a mold to form pieces, and at least partially cooking the pieces in the mold, or cooking the pieces following removal from the mold.

In some embodiments, a method of making a shelf stable baked brownie can include applying a fat-based coating to at least a portion of a surface of the brownie.

### DETAILED DESCRIPTION

Consumption of hydrolyzed collagen has been shown to provide skin health benefits. However, such benefits require consuming relatively large amounts of hydrolyzed collagen. Although capsules and other supplement forms containing hydrolyzed collagen can be a convenient way to consume enough hydrolyzed collagen to achieve a skin health benefit, consuming supplements isn't generally considered enjoyable by most consumers. Alternatively, foods containing hydrolyzed collagen have been developed to provide a more enjoyable way to consume hydrolyzed collagen. However, the foods available contain relatively low levels of hydrolyzed collagen by weight, so skin health benefits that might be achieved by these foods require consuming more than some consumers would prefer. As a result, consumers must either eat a lot of these foods to achieve a skin health benefit and accept increased cost, calorie intake, or reduced enjoyment at having to eat a lot of a single food type, or accept that skin health benefits may not be achieved.

The inventors of the present application were tasked with producing a brownie containing a high amount of hydrolyzed collagen by weight (e.g., at least 8%, at least 9%, or about 10% hydrolyzed collagen by weight) while also providing a good flavor and good texture that remained stable over a room temperature shelf life of at least 4 months (e.g., at least 6 months, or at least 8 months). In some embodiments, a single serving of a brownie provided herein can provide an amount of hydrolyzed collagen (e.g., at least 2.5 g) that has been clinically shown to provide a skin health benefit when consumed daily.

It was discovered, and is described herein, that a particular combination of “pantry friendly” ingredients, including gluten-free flour, chia seed, and moisture, mainly in the form of syrups, along with a high level of hydrolyzed collagen to produce a soft baked brownie product that imparts an indulgent flavor and texture, and does not significantly harden or develop a dry eating experience over shelf life of at least 4 months (e.g., at least 6 months, or at least 8 months). In addition, a soft baked brownie provided herein can advantageously provide a relatively high protein content (e.g., about 15% to about 30%, or about 16% to about 24%) compared to many available shelf stable brownie products. In some embodiments, a brownie provided herein can contain less than 35% (e.g., less than 32%, or about 30%) by weight sugar. It is particularly unexpected that an indulgent flavor and texture can be achieved without the use of sugar alcohols (e.g., glycerol, erythritol, maltitol, and the like), gums (e.g., locust bean gum, acacia gum, carrageenan, xanthan gum, and the like), and high intensity sweeteners (e.g., stevia extract, monkfruit extract, aspartame, and the like).

As used herein, the term “soft baked snack” refers to food that is baked from a dough or batter to achieve a finished product moisture of about 6% to 14% (e.g., 8 to 14%, or 9% to 12%), with a soft, chewy texture and a crumb structure reminiscent of brownies. Such a soft baked snack does not resemble crunchy or hard cookies, hard biscuits, or crackers, which typically have a moisture content of 5% or less. Nor does such a soft baked snack resemble confections, such as nougat or caramel, which typically do not have a crumb structure, and are not baked.

A brownie provided herein has a stable texture and perceived moistness over a packaged shelf life of at least 4 months (e.g., at least 6 months, or at least 8 months). A water activity of less than 0.7 (e.g., less than 0.65) can contribute to the packaged shelf life.

The brownie provided herein includes a matrix in an amount of 65% to 100% by weight of the soft baked snack, with optional inclusions in an amount of up to 35% (e.g., from about 5% to 35%, about 10% to about 20%, or about 10% to about 15%) by weight of the soft baked snack distributed throughout the matrix. The matrix of a soft baked brownie can include protein in an amount of about 15% to about 30% (e.g., about 16% to about 24%) by weight.

Protein in the matrix of a brownie includes hydrolyzed collagen. As used herein, the term “hydrolyzed collagen” refers to native collagen (an insoluble, triple helical protein) that has been hydrolyzed, typically by enzymes, to form single-stranded peptides that are soluble in hot or cold water and do not form a gel. Hydrolyzed collagen is also sometimes referred to as “collagen peptides.” As used herein, hydrolyzed collagen does not refer to gelatin, which is partially hydrolyzed collagen, typically by heat and/or chemical treatment, that is soluble in hot water and can form a gel. A hydrolyzed collagen suitable for use in brownie provided herein has an average molecular weight of 10,000 g/mol or less (e.g., less than 7,000 g/mol, or from about 1,500 to about 3,000 g/mol).

Hydrolyzed collagen is included in the matrix of a soft baked snack in an amount of from about 8% to about 14% (e.g., about 8% to about 12%, or about 8% to about 10%) by weight of the matrix. Although it was found that amounts of collagen above 7% by weight of a soft baked snack can contribute to a poor flavor, the present invention surprisingly overcomes previous flavor issues. Also, although collagen can also impact spread of a dough used to make a soft baked snack provided herein, which can impact the dimensions, and subsequent manufacturability, the present formulation achieves surprising flexibility in manufacturing.

Flour is included in a brownie matrix provided herein in an amount of about 15% to about 30% (e.g., about 17% to about 29%, or about 20% to about 25%) by weight of the matrix. Flour content of a brownie matrix includes a flour derived from a source that does not contain gluten in an amount of at least 50% (e.g., at least 60%, or at least 70%) by weight of the flour content. In some embodiments, a gluten-free flour can be combined with a wheat flour in a ratio of about 3:1. In some embodiments, only gluten-free flour is included in a brownie matrix. Surprisingly, even though soft baked brownie texture is typically associated with the inclusion of a gluten-containing flour, a soft baked brownie provided herein can deliver such a texture, even with little or no gluten content. In fact, a brownie made with a flour content that consisted of wheat flour (i.e., a flour content with 100% gluten-containing flour) was found to be too dry and less indulgent, even if additional oil was added.

Suitable gluten-free flours include those derived from sources that do not naturally contain gluten, such as nuts (e.g., almond, cashew, coconut, and the like, or combinations thereof), seeds (e.g., quinoa, buckwheat, millet, sesame, and the like, or combinations thereof), gluten-free grains (e.g., oat, corn, rice, and the like or any combination thereof), pulses or legumes (e.g., lupin, chickpea, soy, peanut, and the like, or any combination thereof), or roots (e.g., potato, cassava, tapioca, and the like, or any combination thereof). Preferably, a gluten-free flour also contains at least 15% by weight protein so that it can contribute to a preferred protein content. Gluten-free flours containing at least 15% by weight flour include, for example, almond flour, peanut flour, chickpea flour, coconut flour, lupin flour, lentil flour, soy flour, and sesame flour. Almond flour is a particularly useful gluten-free flour because it provides a good texture, a fairly neutral flavor, and contributes to protein content.

In some embodiments, the flour content of the matrix can contribute protein in an amount of at least 10% (e.g., about 15% to about 25%) by weight of total protein in a brownie provided herein.

Chia seed is included in a brownie matrix in an amount of about 1% to about 6% (e.g., about 2% to about 5%) by weight of the matrix. Chia seed in ground form can provide a manufacturing benefit by reducing the time to provide at least partial hydration, as described below. However, whole chia seeds can also be used. It was discovered that chia seed unexpectedly contributed to a soft texture when combined with high levels of hydrolyzed collagen in a way that other ingredients that could act as humectants, such as egg ingredients or syrups, could not. If chia seed was excluded or included at a rate of less than 1%, the baked product would be crispy, with a texture similar to Styrofoam. In addition, the described range of chia seed can benefit manufacture by contributing to a dough rheology that is more pliable, whereas a dough that excludes chia became stiff and difficult to work with.

The matrix of a soft baked snack provided herein also includes syrup in an amount of from about 12% to about 21% (e.g., about 14% to 20%, or about 15% to about 18%) by weight of the matrix. As used herein, “syrup” refers to a viscous liquid food ingredient with a moisture content of less than 35% (e.g., 30% or less). Syrup in a soft baked brownie provided can include, for example, sugar syrups (e.g., honey, fruit juice concentrates, molasses, maple syrup, tapioca syrup, corn syrup, and the like) or fiber syrups (e.g., liquid inulin, soluble corn fiber, fructooligosaccharides, polydextrose, β-glucan, isomalto-oligosaccharides, galacto-oligosaccharides, arabinoxylans, and the like), and combinations thereof.

Particularly suitable is a combination of a fiber syrup, such as soluble corn fiber and/or inulin, and a sugar syrup, such as honey, molasses, and/or maple syrup, to provide a sweet flavor while also maintaining a sugar content of less than 35% (e.g., less than 32%) by weight of the brownie. In some embodiments, a sugar syrup can be included in an amount of about 5% to about 17% by weight of the matrix. In some embodiments, a fiber syrup can be included in an amount of about 7% to about 17% by weight of the matrix.

In some embodiments, a ratio of fiber syrup to sugar syrup can be from about 2:1 to about 1:2 (e.g., about 1.5:1 to 1:1.5, or about 1:1) by weight. Syrup content can contribute to a moist eating experience, especially with a relatively low fat content.

The matrix of a brownie provided herein includes fat in an amount of from about 8% to about 12% (e.g., about 9% to about 11%) by weight of the matrix. Suitable fats can be either solid or liquid at room temperature. Suitable fats include, without limitation, canola oil, peanut oil, soybean oil, coconut oil, cottonseed oil, lard, olive oil, butter, and the like, and any combination thereof. In some embodiments, a fat can contribute to a preferred flavor profile. For example, coconut oil can be selected to impart some coconut flavor, while canola oil can impart little to no flavor. In some embodiments, a fat can contribute to a soft texture in a brownie provided herein. In some embodiments, a fat can impact spread of a dough used to make a brownie provided herein, which can impact the dimensions of a brownie provided herein. As used herein, a fat included in a brownie matrix does not refer to fat content from any other ingredient, such as almond flour or cocoa powder.

The matrix of a soft baked snack provided herein also includes dry sugar in an amount of from 8% to 16% (e.g., 10% to 15%) by weight of the soft baked snack. As used herein, “dry sugar” refers to a solid sugar rather than a syrup. Suitable sugars can be flaked, granulated, powdered, or the like. Dry sugar preferably comprises sucrose.

In some embodiments, a matrix can include cocoa powder in an amount of up to 7% (e.g., about 2% to about 6%) by weight of the matrix.

In some embodiments, a matrix can include egg white in an amount of up to 2% (e.g., about 0.5% to about 1.5%) by weight of the matrix.

Other suitable ingredients, such as flavorants (e.g., salt, vanilla, spices, and the like), colorants (e.g., fruit and/or vegetable juices and/or extracts, and the like), fortifications (e.g., vitamins, minerals, and the like), salts from leavening agents, and other minor ingredients can be included in amounts of up to about 2% each, in a total amount of up to 8% by weight of the matrix.

Inclusions can optionally be included in a soft baked brownie provided herein. If included, inclusions can be included in an amount of up 35% (e.g., about 5% to 35%, or about 10% to about 20%) by weight of the brownie. Suitable inclusions include, for example, fat-based chips (e.g., chocolate and/or compound chips, or the like), nuts or nut pieces, dried fruit pieces, confection pieces, and the like, or any combination thereof. In some embodiments, inclusions can contribute to a desired texture, flavor, and overall eating experience. For example, chocolate chips can be used to increase chocolate flavor and/or contribute to a decadent eating experience. In some embodiments, inclusions can be selected to contribute to an overall nutritional profile. For example, nuts or nut pieces can be used to increase total protein content of a brownie described herein.

A coating, frosting, drizzle, or other surface ingredient can optionally be included on at least a portion of a surface of a brownie provided herein. Fat-based coatings (e.g., as a frosting, coating, or drizzle) can be included in an amount of up to about 20% (e.g., up to 15%, or up to 10%) by weight of a brownie provided herein. Other surface ingredients, such as nuts or nut pieces, fat-based chips, dried fruit pieces, confection pieces, and the like can be used to provide visual interest, textural variation, and/or flavor.

Methods of making a soft baked brownie are provided herein. A method includes combining ingredients described above to achieve a dough or batter having a moisture content of about 10% to about 45% (e.g., about 12% to about 42%). Generally, a dough has a lower moisture content, while a batter has a higher moisture content. Surprisingly, despite the wide range of moisture levels in a dough or batter, it was discovered that the final product could be successfully baked to a moisture content of about 6% to about 14% by weight to produce a shelf-stable produce as described above. The range of moisture content in a dough or provides manufacturing flexibility, while still providing an acceptable product once baked.

Preferably, a dough or batter is produced by first at least partially hydrating the chia seed in water. The amount of water can be adjusted to arrive at a desired dough moisture content (in addition to syrup ingredients) and hydration of the chia seeds. It was discovered that chia seed need not be fully hydrated prior to combining with other ingredients to achieve the benefits described above. In some cases, chia seed may remain partially hydrated during the production of a brownie provided herein. In some cases, chia seed may remain partially hydrated through at least part of shelf life.

Following at least partial hydration of chia seed, the at least partially hydrated chia seed can be combined with syrup ingredients and fat in liquid form (i.e., melted if not liquid at ambient temperature) to form a liquid mixture. It is to be understood that the mixture need not be fully mixed at this point. That is, the fat and water-based ingredients need not be emulsified.

The liquid mixture is then combined with one or more flour and hydrolyzed collagen to form the dough or batter. In some embodiments, a dough or batter also includes a leavening agent. A leavening agent (e.g., baking powder, baking soda, or the like), typically in an amount of about 0.1% to about 1% by weight of the dough or batter, can contribute to a desired crumb structure. A leavening agent need not include both a leavening acid and leavening base, as one or the other may react with ingredients in the dough or batter to provide leavening. Other matrix ingredients described above can be added at this step, as well.

A dough or batter can be made using any appropriate method, including batch mixing or a continuous process. A dough or batter can then be formed and cooked to a moisture content of 6% to 14% (e.g., 8 to 12%) to form a soft baked brownie as described herein.

A dough or batter can be formed using any appropriate method. Forming method may be selected based on the moisture and/or rheology of the dough or batter, the desired appearance of the final product, and/or the equipment available for forming the dough or batter. In some embodiments, particularly suitable for a dough, a slab can be formed that can be cut into pieces before or after cooking. In some embodiments, a rope can be formed from a dough or batter, and the rope can be cut or pinched into pieces before or after cooking. In some embodiments, a dough or batter can be formed (e.g., extruded) into individual pieces prior to cooking. In yet other embodiments, a dough or batter can be deposited into a mold to form pieces, and the dough or batter can be at least partially cooked in the mold, or the pieces can be removed from the mold before cooking.

The dough or batter can be combined with inclusions, if desired, prior to forming.

Application of a coating, drizzle, or other surface adornments and ingredients can be applied before or after cooking using any appropriate method.

A brownie provided herein can be packaged in any suitable packaging, including single serving and multi-serving packages. In some embodiments, packaging that resists moisture transfer and/or oxygen transfer into or out of the packaging can be used.

The implementations described above and other implementations are within the scope of the following claims. One skilled in the art will appreciate that the present disclosure can be practiced with embodiments other than those disclosed.

The following examples are presented for purposes of illustration and not limitation.

What is claimed is:

1. A shelf stable baked brownie, the brownie having a total protein content of from about 15% to about 30% by weight of the brownie, a moisture content of about 6% to about 14% by weight, and a water activity (Aw) of less than 0.7, the brownie having a stable texture over at least 4 months, where the brownie comprises a matrix in an amount of at least 65% by weight of the brownie, the matrix including:
a. flour content in an amount of about 15% to about 30% by weight of the matrix, the flour content comprising a flour derived from a source that does not contain gluten in an amount of at least 50% by weight of the flour content;
b. hydrolyzed collagen in an amount of about 8% to about 14% by weight of the matrix, the hydrolyzed collagen having an average molecular weight of 10,000 g/mol or less;
c. chia seed in an amount of about 1% to about 6% by weight of the matrix;
d. one or more syrup in an amount of about 12% to about 21% by weight of the matrix; and
e. fat in an amount of about 7% to about 12% by weight of the matrix.

2. The brownie of claim 1, wherein the flour content contributes protein in an amount of at least 10% by weight of the total protein content.

3. The brownie of claim 2, wherein the flour content comprises almond flour.

4. The brownie of claim 1, wherein the flour content is 100% derived from a source that does not contain gluten.

5. The brownie of claim 1, wherein the matrix comprises cocoa in an amount of up to 7% by weight of the matrix.

6. The brownie of claim 1, wherein the syrup comprises one or more of honey, soluble corn fiber, inulin, or any combination thereof.

7. The brownie of claim 6, wherein the syrup comprises honey in an amount of about 5% to about 17% by weight of the matrix.

8. The brownie of claim 6, wherein the syrup comprises soluble corn fiber in an amount of about 7% to about 17% by weight of the matrix.

9. The brownie of claim 1, wherein the fat comprises coconut oil.

10. The brownie of claim 1, wherein the brownie contains no sugar alcohol, no gums, no high fructose corn syrup, and no high intensity sweeteners.

11. The brownie of claim 1, wherein the brownie contains less than 35% by weight sugar.

12. A method of making a shelf stable baked brownie, the method comprising:
a. at least partially hydrating chia seed in water;
b. combining the at least partially hydrated chia seed with one or more syrup and a fat in liquid form to form a liquid mixture;
c. combining the liquid mixture with one or more flour and hydrolyzed collagen to form a dough or batter, the dough or batter having a moisture content of about 10% to about 45%;
d. forming the dough or batter;
e. cooking the formed dough or batter to achieve a moisture of about 6% to about 14% to produce the brownie, the brownie having a matrix in an amount of at least 65% by weight of the brownie, the matrix comprising:
1) flour content in an amount of about 15% to about 30% by weight of the matrix, the flour content comprising the one or more flour, wherein at least one of the one or more flour is derived from a source that does not contain gluten and is included in an amount of at least 50% by weight of the flour content;
2) the hydrolyzed collagen in an amount of about 8% to about 14% by weight of the matrix, the hydrolyzed collagen having an average molecular weight of 10,000 g/mol or less;
3) the chia seed in an amount of about 1% to about 6% by weight of the matrix;
4) the one or more syrup in an amount of about 12% to about 21% by weight of the matrix;
5) the fat in an amount of about 8% to about 12% by weight of the matrix.

13. The method of claim 12, wherein the method comprises combining inclusions with the dough or batter prior to forming.

14. The method of claim 12, wherein the dough or batter comprises a leavening agent.

15. The method of claim 12, wherein the forming step comprises forming a flat slab and cutting the flat slab into pieces prior to or after cooking.

16. The method of claim 12, wherein the forming step comprises forming a rope and cutting the rope prior to or after cooking.

17. The method of claim 12, wherein the forming step comprises extruding individual pieces.

18. The method of claim 12, wherein the forming step comprises depositing the dough or batter in a mold to form pieces, and at least partially cooking the pieces in the mold, or cooking the pieces following removal from the mold.

19. The method of claim 12, wherein the method comprises applying a fat-based coating to at least a portion of a surface of the brownie.
